(19) United States
(12) Patent Application Publication
(10) Pub. No.: US 2026/0311093 A1
(43) Pub. Date: Oct. 8, 2026

(54) AI-AUGMENTED WORKFLOW AUTOMATION

(71) Applicant: NOMINAL LTD., Rishon Le-Zion (IL)

(72) Inventors: Golan KOPICHINSKY, Rishon Le-Zion (IL); Evyatar VANUNU, Herzliya (IL)

(21) Appl. No.: 19/171,669

(22) Filed: Apr. 7, 2025

(51) Int. Cl. G06Q 10/0633; G06F 40/40

(52) U.S. Cl. CPC G06Q 10/0633; G06F 40/40

(57) ABSTRACT

A computer-implemented method comprising: receiving, as input, a natural language description of a workflow associated with a process-of-interest; processing the natural language description to generate a structured process flow configured to execute the process-of-interest, wherein the process flow comprises a trigger event, one or more inputs, one or more discrete action steps, and a final action; generating at least one condition applicable to the execution of the process-of-interest; and upon detecting the trigger event, executing the structured process flow.

### BACKGROUND

The present application generally relates to information technology and, more particularly, to automation tools.

Processes are employed by enterprises and businesses to serve enterprise purposes and goals, such as providing services, or performing administrative or regulatory requirements. Processes or functions are typically comprised of a series of steps or actions performed by various entities within the enterprise according to a specific sequence, to produce the desired goal. Thus, processes may typically be visualized or modeled as a flowchart comprising inputs, activities, decision points, and rules. The benefits of using defined processes within an enterprise include improved efficiency, consistency, and internal controls.

Enterprises may wish to automate repeated processes and functions that are human-intensive, to reduce costs, increase speed, accuracy and consistency, and improve quality and scalability. Automation can also provide extra security, especially for sensitive data and financial services. However, traditional rule-based automation often falls short in handling complex scenarios requiring integrating multi-modal structured and unstructured input data from multiple sources, contextual understanding, step-by-step validation, and adaptive decision-making.

Accordingly, there is an unmet need for artificial intelligence-augment process automation, which will monitor events across multiple systems, analyze them through structured processing and intelligent validation, and recommend appropriate action.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in an embodiment, a computer-implemented method comprising: receiving, as input, a natural language description of a workflow associated with a process-of-interest; processing the natural language description to generate a structured process flow configured to execute the process-of-interest, wherein the process flow comprises a trigger event, one or more inputs, one or more discrete action steps, and a final action; generating at least one condition applicable to the execution of the process-of-interest; and upon detecting the trigger event, executing the structured process flow.

There is also provided, in an embodiment, a system comprising at least one hardware processor; and a non-transitory computer-readable storage medium having stored thereon program instructions, the program instructions executable by the at least one hardware processor to: receive, as input, a natural language description of a workflow associated with a process-of-interest, process the natural language description to generate a structured process flow configured to execute the process-of-interest, wherein the process flow comprises a trigger event, one or more inputs, one or more discrete action steps, and a final action, generate at least one condition applicable to the execution of the process-of-interest, and upon detecting the trigger event, execute the structured process flow.

There is further provided, in an embodiment, a computer program product comprising a non-transitory computer-readable storage medium having program instructions embodied therewith, the program instructions executable by at least one hardware processor to: receive, as input, a natural language description of a workflow associated with a process-of-interest; process the natural language description to generate a structured process flow configured to execute the process-of-interest, wherein the process flow comprises a trigger event, one or more inputs, one or more discrete action steps, and a final action, generate at least one condition applicable to the execution of the process-of-interest; and upon detecting the trigger event, execute the structured process flow.

In some embodiments, the process-of-interest is any repeated or ad-hoc process defined using a workflow or procedure steps.

In some embodiments, the natural language description identifies at least one of the following categories of elements of the process-of-interest: one or more inputs, the trigger event, one or more the action steps, one or more entities responsible for performing each of the one or more action steps, a sequential ordering of the one or more action steps, interdependency between the one or more action steps, the at least one condition, or the final action.

In some embodiments, the one or more inputs comprise structured and unstructured inputs.

In some embodiments, the processing is based, at least in part, on natural language processing (NLP) comprising one or more of natural language understanding (NLU), semantic analysis, contextual analysis, or syntactic analysis.

In some embodiments, the processing is based, at least in part, on applying a reasoning large language model (LLM).

In some embodiments, the at least one condition is configured one or more of the following: validate the trigger event, validate the inputs, halt the execution of the structured process flow when no further action is necessary, or pause the execution of the structured process flow when human intervention is necessary.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 shows a block diagram of an exemplary computing environment, comprising a computing system configured to execute at least some of the computer code involved in performing the inventive methods.

FIGS. 2A-2C depict exemplary processes which may be implemented using the present technique for automatically generating a set of actions which execute a process-of-interest, from a natural language description of a workflow associated with the process-of-interest.

FIG. 3 is a block diagram which illustrates the functional steps in a method which provides for automatically generating a structured process flow comprising a set of discrete actions which execute a process-of-interest, from a natural language description of a workflow associated with the process-of-interest.

FIG. 4 illustrates the various steps in a method which provides for automatically generating a structured process flow comprising a set of discrete actions which execute a process-of-interest, from a natural language description of a workflow associated with the process-of-interest.

FIG. 5 depicts an exemplary case of generating structured process flow comprising a set of discrete actions, based on a natural language description of a workflow associated with a process-of-interest.

### DETAILED DESCRIPTION

Disclosed herein is a technique, embodied as a computer-implemented method, a system, and a computer program product, which provides for automatically generating a structured process flow comprising a set of discrete actions which execute a process-of-interest, from a natural language description of a workflow associated with the process-of-interest.

The process-of-interest may be any repeated or ad-hoc process that may be defined using a workflow or procedure steps. The workflow identifies the inputs to the process, the different steps for performing the process, the entities responsible for performing each step, the sequential ordering of the steps, interdependency between two or more steps, applicable rules, decision points, and expected outputs of each step and of the process as a whole.

In one example, the process-of-interest may be associated with the typical functions of an enterprise, such as marketing, sales, billing, procurement, accounting, regulatory compliance, and the like. A process may be related to a service or good provided by an enterprise, such as handling of client calls, or scheduling appointments. A process may also be related to a method or steps that are carried out by an enterprise for administrative purposes, such as processing invoices, hiring a new employee, or the like.

In some embodiments, the present technique provides for receiving natural language instructions, wherein the natural language instructions include instructions for executing a process, comprising, but not limited to, the inputs to the process, one or more action steps for performing the process, one or more the entities responsible for performing the various action steps, the sequential ordering of the action steps, interdependency between two or more action steps, applicable rules, decision points, and expected outputs of each step and of the process as a whole.

The present technique generates, based on the natural language instructions, a series of action steps which process structured and unstructured input data, and transform it into structured output for discrete actions and a final intent. In some embodiments, each of the action steps and the final action intent may be represented in natural language. In some embodiments, each of the action steps comprises an execution step and a validation step.

In some embodiments, the use of action steps comprising natural language ensures adaptability across different inputs by focusing on semantic logic rather than rigid procedural rules. Thus, each process execution progresses through a sequence of execution steps, where each step contains an action logic written in natural language, which may be executed using relevant computational systems and tools.

In some embodiments, the present technique follows a structured, multi-step pipeline, configured to process events and information, and to generate action steps. In some embodiments, the multi-step pipeline begins with a natural language set of instructions which describe a workflow. The natural language instructions or description comprises the relevant event and information stream, any conditions for items in the stream, and the task itself. Based on the natural language description, a specialized machine learning model translates and converts it into process flow components:
One or more trigger events.
Input data sources, tools, and support systems.
Rules and conditions (which may be deterministic or non-deterministic).
One or more action steps.
Final action.

Trigger events and data may originate from multiple sources, including structured data sources (e.g., computer systems and API feeds) or unstructured sources (text messages, emails, scanned documents, reports). Each trigger represents a potential process or transaction, requiring classification and processing.

In some embodiments, the present technique provides for a filtering mechanism to eliminate non-relevant events and data. In some embodiments, the present technique employs a two-stage filtering approach:
Deterministic filter: A rule-based mechanism that eliminates irrelevant events based on predefined conditions.

Adaptive filter: An adaptive filtering mechanism, which may be powered by an LLM, that can identify meaningful patterns and nuances in data.

In some embodiments, each action step utilizes one or more tools from a set of tools, including:
Retrieval-augmented generation (RAG): Retrieval-augmented generation is configured to retrieve and incorporate new information that is relevant to the execution of the action step. RAG can be used to supplement information from internal enterprise data stores or approved sources.
API calls: Interfaces with other enterprise and external systems and software, to retrieve relevant trigger events and data.
Reasoning LLM model: Interprets context and generates structured recommendations that require multi-step generation with intermediate steps.
Validation model: A specialized LLM validation model that evaluates the output of each action step, and enforces re-execution when the output fails validation. The validation model acts as a self-correcting mechanism which ensures accuracy and reliability in the overall task execution.

In some embodiments, the present technique provides for a shared data store which stores the inputs and outputs of each action step, and provides for efficient management of context. Using the shares storage, the present technique ensures that all essential information remains available for subsequent steps.

A potential benefit of the present technique is, therefore, in that it provides for automation of complex tasks and workflows across multiple inputs and systems, with the ability to monitor and interpret structured and unstructured events. The present technique ensures accuracy of execution by performing real-time validation of each action step and by requiring deterministic outputs with clear success or failure criteria. The present technique further requires minimal manual intervention while maintaining traceability.

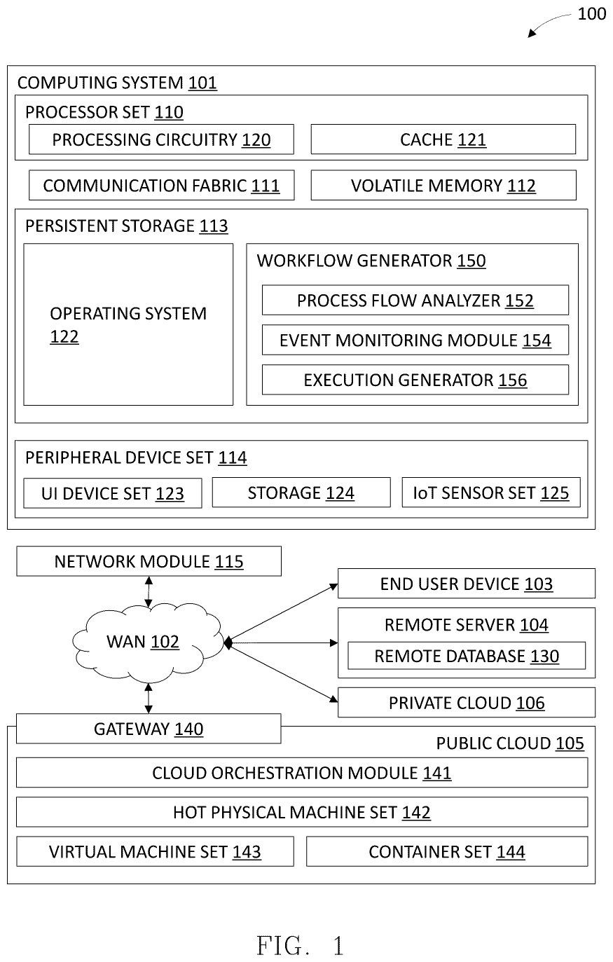

Reference is now made to FIG. 1, which shows a block diagram of an exemplary computing environment 100, comprising a computing system 101 configured to execute at least some of the computer code involved in performing the present inventive methods.

Computing environment 100 includes, for example, a computing system 101, a wide area network (WAN) 102, an end user device (EUD) 103, a remote server 104, a public cloud 105, and/or a private cloud 106. In this example, computing system 101 includes a processor set 110 (including processing circuitry 120 and a cache 121), a communication fabric 111, a volatile memory 112, a persistent storage 113 (including an operating system 122 and a workflow generator block 150), a peripheral device set 114 (including a user interface (UI), a device set 123, a storage 124, and an Internet of Things (IoT) sensor set 125), and a network module 115. Remote server 104 includes a remote database 130. Public cloud 105 includes a gateway 140, a cloud orchestration module 141, a host physical machine set 142, a virtual machine set 143, and a container set 144.

Computing system 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network and/or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computing system 101, to keep the presentation as simple as possible. computing system 101 may be located in a cloud, even though it is not shown in a cloud in FIG. 1. On the other hand, computing system 101 is not required to be in a cloud except to any extent as may be affirmatively indicated.

Processor set 110 includes one or more computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computing system 101 to cause a series of operational steps to be performed by processor set 110 of computing system 101 and thereby effect a computer-implemented method, such that the instructions thus executed will instantiate the method(s) specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computing system 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computing system 101, volatile memory 112 is located in a single package and is internal to computing system 101, but, alternatively or additionally, the volatile memory may be distributed over multiple packages and/or located externally with respect to computing system 101.

Persistent storage 113 is any form of non-volatile storage for computers that is now known or to be developed in the future. The non-volatility of this storage means that the stored data is maintained regardless of whether power is being supplied to computing system 101 and/or directly to persistent storage 113. Persistent storage 113 may be a read-only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open source Portable Operating System Interface type operating systems that employ a kernel.

The code included in block 150 typically includes at least some of the computer code involved in performing the inventive methods, including a process flow analyzer 152, an event monitoring module 154, and/or an execution generator 156.

Peripheral device set 114 includes the set of peripheral devices of computing system 101. Data communication connections between the peripheral devices and the other components of computing system 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the Internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computing system 101 is required to have a large amount of storage (for example, where computing system 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computing system 101 to communicate with other computers through WAN 102. Network module 115 may include hardware, such as a network interrace controller (NIC), a modem, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computing system 101 from an external computer or external storage device through the hardware included in network module 115.

WAN 102 is any wide area network (for example, the Internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computing system 101), and may take any of the forms discussed above in connection with computing system 101. EUD 103 typically receives helpful and useful data from the operations of computing system 101. For example, in a hypothetical case where computing system 101 is designed to provide a recommendation to an end user, this recommendation would typically be communicated from network module 115 of computing system 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computing system 101. Remote server 104 may be controlled and used by the same entity that operates computing system 101. Remote server 104 represents the machine(s) that collect and store helpful and useful data for use by other computers, such as computing system 101. For example, in a hypothetical case where computing system 101 is designed and programmed to provide a recommendation based on historical data, then this historical data may be provided to computing system 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the Internet entirely and only accessible through a local/private network. A hybrid cloud is a composition of multiple clouds of different types (for example, private, community or public cloud types), often respectively implemented by different vendors. Each of the media signal the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

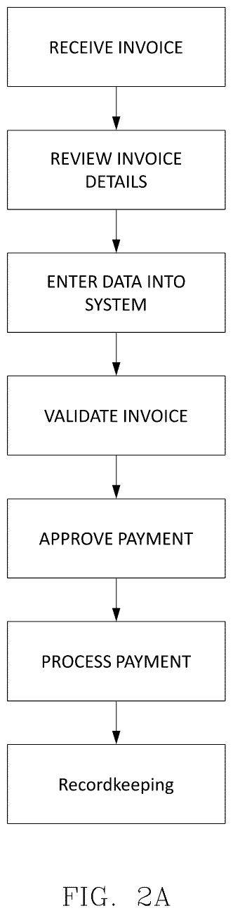

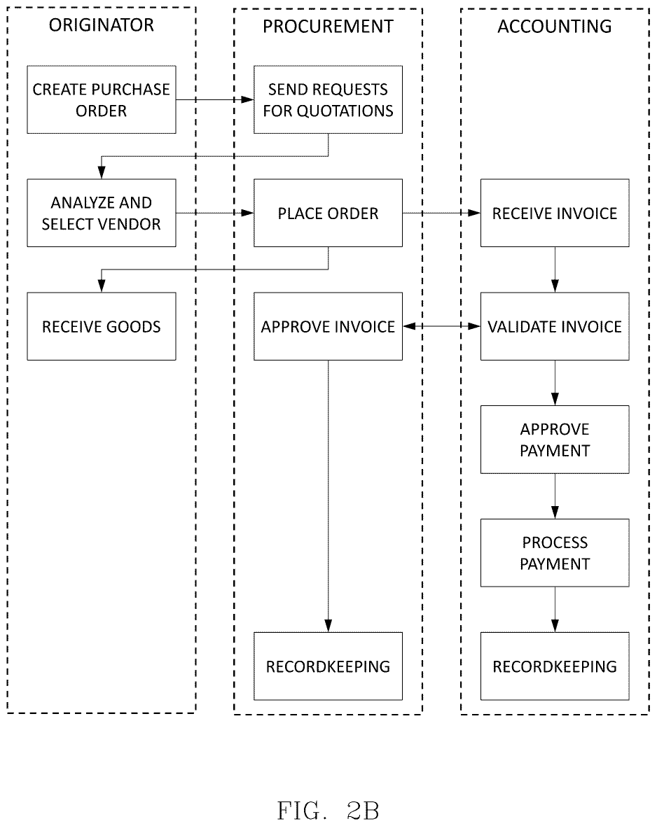

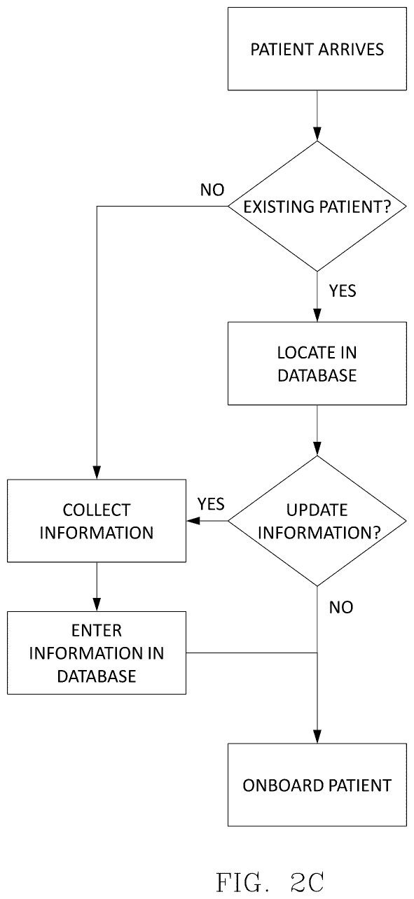

FIGS. 2A-2C depict exemplary processes which may be implemented using the present technique for automatically generating a set of actions which execute a process-of-interest, from a natural language description of a workflow associated with the process-of-interest.

FIG. 2A depicts an exemplary invoice processing workflow, comprising the steps of:
Receiving an invoice for payment, e.g., from a vendor who delivered goods or services. The invoice may arrive via mail, email, or through a dedicated accounting system. Receiving the invoice may be a trigger event for executing the invoice processing workflow.
Reviewing invoice details to make sure that all the necessary information is included.
Entering invoice data into the relevant accounting system.
Validating the invoice against one or more other sources, such as corresponding purchase order, delivery receipt, etc.
Approving invoice payment by the appropriate entity, such as the accounts payable department.
Processing invoice payment, e.g., via wire transfer, credit card charge, or any other suitable method.
Performing required recordkeeping, including recording the transaction into the general ledger and storing the invoice.

FIG. 2B depicts an exemplary purchasing order workflow, which involves multiple steps performed by different entities. Thus, the workflow execution comprises different “lanes”—sequences of action steps performed by respective entities within an enterprise, including the purchase order originator, a procurement department, and an accounting department:
Creating a purchase order by an originator.
Sending requests for quotation (RFQ) by the procurement department.
Analyzing responses and selecting a vendor a by the originator.
Negotiating and placing an order by the procurement department.
Receiving the goods or services by the originator.
Receiving an invoice from the selected vendor by the procurement department.
Validating the invoice by the accounting and/or procurement departments.
Approving and processing payment by the accounting department.
Performing required recordkeeping by the accounting and procurement departments.

FIG. 2C depicts an exemplary patient check-in process, e.g., for an appointment at a medical facility. This process comprises action steps (represented by rectangles) as well as decision points (represented by diamonds), in which a determination is made based on specific information, which may lead to different actions depending on the determination:
Receiving an arriving patient at the facility.
Decision point: Checking whether patient is an existing or new patient.
   New patient: Collecting personal, demographic, clinical, and/or insurance information.
   Existing patient—decision point: Checking whether the information on file requires updating.
      Update required: Collecting updated personal, demographic, clinical, and/or insurance information.
   Entering the collected information in database.
Admitting the patient for the scheduled appointment.

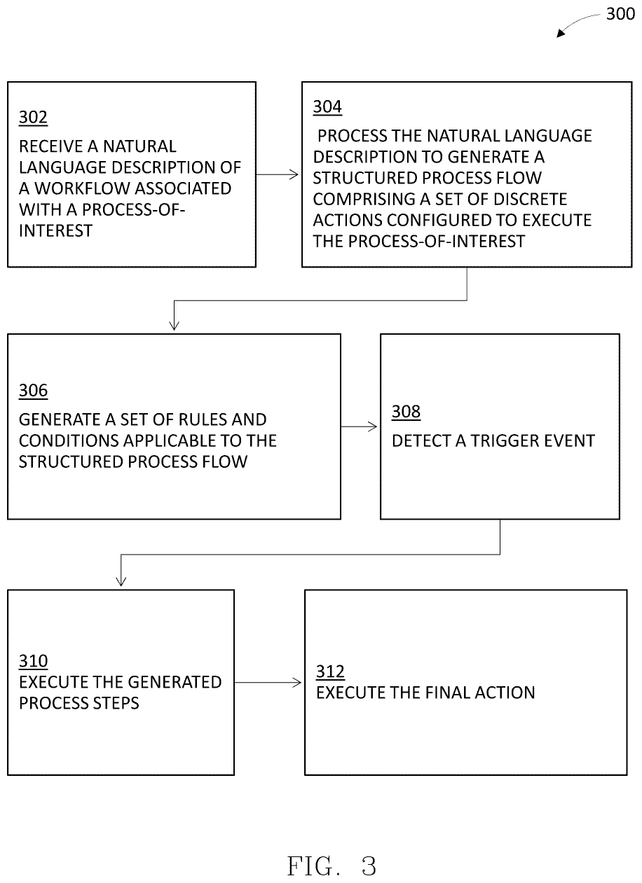

The instructions of workflow generator 150 are now discussed with reference to the flowchart of FIG. 3, which illustrates a method 300 which provides for automatically generating a structured process flow comprising a set of discrete actions which execute a process-of-interest, from a natural language description of a workflow associated with the process-of-interest.

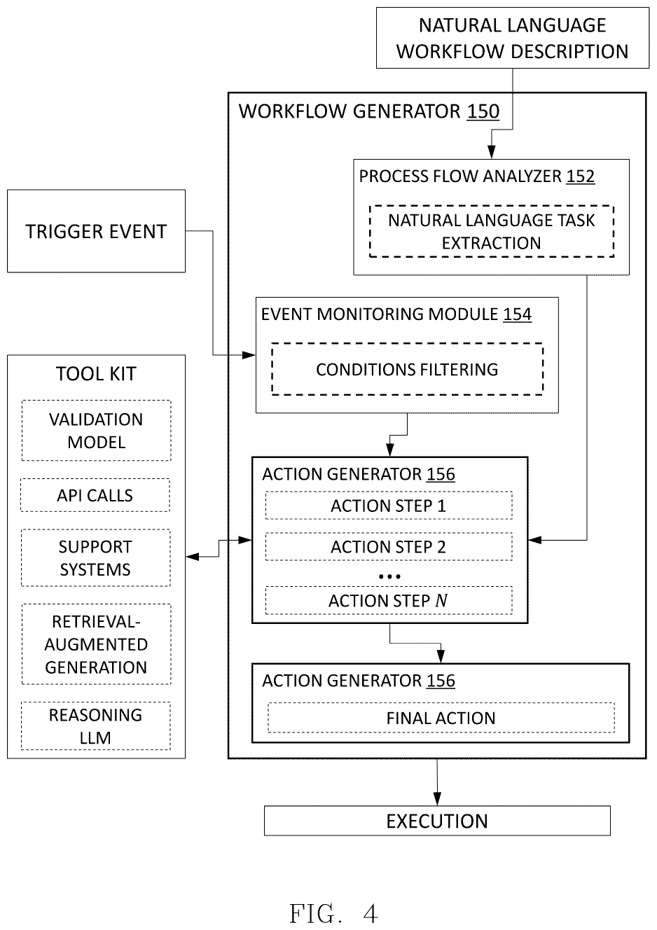

The steps of method 300 are described with continued reference to the exemplary computing system 101 of FIG. 1, and to the block diagram of FIG. 4, which illustrates the various steps in method 300.

Steps of method 300 may either be performed in the order they are presented or in a different order (or even in parallel), as long as the order allows for a necessary input to a certain step to be obtained from an output of an earlier step. In addition, the steps of method 300 are performed automatically (e.g., by computing system 101 of FIG. 1, or by any other applicable component of computing environment 100), unless specifically stated otherwise.

Method 300 begins in step 302, wherein workflow generator 150 receives, as input, a natural language description of a workflow associated with a process-of-interest.

The process-of-interest may be any repeated or ad-hoc process that may be defined using a workflow or procedure steps. In one example, the process-of-interest may be associated with the typical functions of an enterprise, such as marketing, sales, billing, procurement, accounting, regulatory compliance, and the like. A process may be related to a service or good provided by an enterprise, such as handling of client calls, or scheduling appointments. A process may also be related to a method or steps that are carried out by an enterprise to process invoices, hire a new employee, or the like.

The process-of-interest may be defined by a process flow that identifies the inputs to the process, the different steps for performing the process, the entities responsible for performing each step, the sequential ordering of the steps, interdependency between two or more steps, applicable rules, decision points, and expected outputs of each step and of the process as a whole.

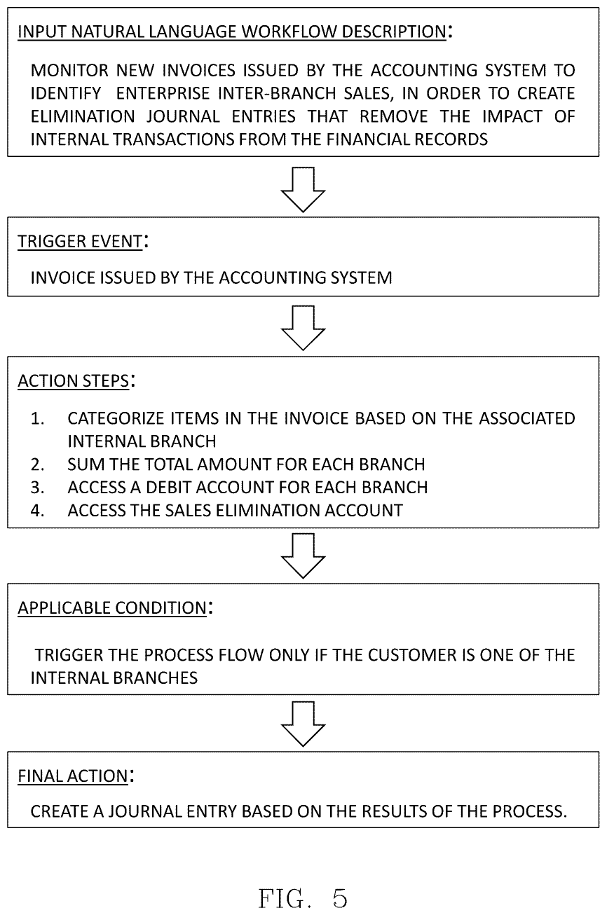

FIG. 5 depicts an exemplary case of generating structured process flow comprising a set of discrete actions, based on a natural language description of a workflow associated with a process-of-interest.

In the example shown in FIG. 5, the natural language description details a process for monitoring new invoices in the accounting system, to identify enterprise inter-branch sales, in order to create elimination journal entries that remove the impact of internal transactions from the financial records.

In some embodiments, the input workflow description may identify one or more of the following categories of workflow features, using natural language:
Trigger event. A trigger event may be any event that triggers or prompts the execution of the process-of-interest. In the example of FIG. 5, the trigger event is receipt of an invoice by the accounting system.
   Trigger events may originate from multiple sources, such as user-initiated entries, system data feeds, emails, reports, and the like. The trigger event itself may be any new entry, record, prompt, document, data item, or information, detected or received, e.g., in any log or feed of a system-of-record. For example, as shown in the example of FIG. 2A, the receipt of an invoice from a vendor may be an event which triggers invoice processing. Similarly, in the example of FIG. 2C, the arrival of a patient at a facility triggers the patient check-in process.
Inputs to the process. Inputs can include any data, information, entries, documents, texts, reports, or the like. Inputs to the process can originate from structured sources, such as API feeds, enterprise financial systems feeds, client relationship management (CRM) system data, enterprise resource planning (ERP) logs, and the like. Inputs to the process can also originate from unstructured sources, including, but not limited to, emails, scanned documents, text reports, and the like. As shown in the example of FIG. 2A, inputs for an invoice processing workflow may include an invoice received from a vendor and a purchase order corresponding to the invoice.
Action steps for performing the process. Each workflow can include one or more action steps, as represented by rectangles in the exemplary processes of FIGS. 2A-2C. Each action step performs a discrete task in the workflow.
Entities responsible for performing each action step. The entities can be individuals, departments or functions within an enterprise, or software systems. As shown in the example of FIG. 2B, different enterprise departments are responsible for different action steps. Thus, the procurement department or function is responsible for sending requests for quotes, issuing purchase orders, validating the details of an invoice received from a vendor in connection with the purchase order, and performing required recordkeeping. The accounting department may be responsible for receiving the invoice, validating the received invoice (which may also involve input from procurement), approving and processing the payment, and performing required recordkeeping.
Sequential ordering of action steps. The ordering of the steps determines whether steps must be performed in a particular temporal order, and/or whether two or more steps can be performed temporally independently of one another, e.g., in parallel. As shown in the example of FIG. 2A, invoice validating must occur before payment approval, and payment approval must occur before payment processing. Conversely, as shown in the example of FIG. 2B, goods or services may be received by a purchase order originator in a parallel sequence that is independent of invoice approval and payment, for example.
Interdependency between two or more action steps. Certain of the action steps may be dependent on one of more action steps. For example, when a necessary input to a certain action step must be obtained from a previous action step. In the example of FIG. 2C, the action step of entering patient information in the database must have as input the patient information collecting is a previous action step.
Decision points. The decision points represent points in the workflow in which in which a determination must be made based on specific information. The determination may lead to different follow-up paths comprising different one or more action steps, depending on the determination. Thus, the use of decision points ensures that the process is adaptable to different scenarios that must be determined in an ad-hoc manner.
   In the example of FIG. 2C, the first decision point is to check whether the arriving patient is a new or existing patient. Depending on the determination, the next action step may be to locate the existing patient in the database, or to collect necessary information from the new patient, as the case may be.
Final intent or output of the process-of-interest. The final intent represents the overall objective or desired output of the process as a whole, which is achieved by the performing the action steps in the intended sequence.

For example, in the case of the invoice processing example of FIG. 2A, the final intent or output may be defined as creating a corresponding journal entry in the accounting system of the organization, scheduling one or more transactions, generating tax document, and/or initiating money transfers. In the case of the example of FIG. 2C, the final intent is to check-in a patient arriving at the facility, to facilitate the provision of medical care to the patient.

In step 304, workflow generator 150 executes process flow analyzer 152 to generate a structured process flow comprising a set of discrete actions, which are configured to execute the process-of-interest associated with the input natural language description received in step 302.

In some embodiments, workflow generator 150 executes process flow analyzer to parses the input natural language description received in step 302, to generate a structured process flow which defines one or more of the following process flow elements:
A process trigger event.
One or more defined inputs and sources to the process.
One or more discrete action steps for performing the process, including any temporal ordering of the action steps, any interdependencies among two or more actions steps, and any decision points.

Entities responsible for performing each of the discrete action steps.
Final intent or output of the process.

In some embodiments, the structured process flow may be rendered in, e.g., natural language, any desired programming language or metalanguage, or using a data exchange format such as JSON.

Returning to the example of FIG. 5, workflow generator 150 may execute process flow analyzer 152 to parse the input natural language description received in step 302, to generate the following a structured process flow:
Trigger event: Issuance of an invoice by the accounting system.

Inputs: Invoice document.
Action steps:
   Categorize items in the issued invoice, based on identifying the associated internal branch (e.g., branch 1, branch 2, branch 3).
   Sum the total amount for each branch.
   Access a debit account for each branch in the accounting system.
   Access a sales elimination account in the accounting system.
Final Action: Create a journal entry which comprises one debit item for each internal branch and a single credit item in the sales elimination account.

In some embodiments, process flow analyzer 152 comprises a natural language processing (NLP) engine configured to apply one or more NLP algorithms or techniques to the input natural language description, to perform one or more types of linguistic processing, such as natural language processing, natural language understanding (NLU), semantic analysis, contextual analysis, syntactic analysis, and the like.

In some embodiments, process flow analyzer 152 comprises a reasoning model, such as a specialized large language model (LLM), configured to break down the input natural language description into discrete action steps, and to apply reasoning which is interlinked through intermediate steps within a chain-of-reasoning.

In some embodiments, process flow analyzer 152 comprises a specialized LLM configured to identify context for each discrete action step in the process flow. The context may be identified as the information surrounding each element within the process flow, such as any relevant information included in the process description, such as entities, systems, tokens, names, inputs, outputs, milestones, temporal connections, semantic connections, and the like. In identifying the context, process flow analyzer 152 the system can analyze the natural language text included in the process flow description, e.g., using natural language or other text analysis techniques.

For example, process flow analyzer 152 may use linguistic processing to establish relationships and context between different parts of the input natural language description. Thus, if process flow analyzer 152 identifies two separate actions, e.g., “send” and “receive,” these disparate actions can be aggregated to understand a relationship between the separate actions and the context of the process as a whole.

In step 306, workflow generator 150 executes process flow analyzer 152 to generate a set of rules and conditions applicable to the structured process flow generated in step 304, based, at least in part, on the input natural language description received in step 302.

In some embodiments, the rules and conditions may set predetermined conditions to ensure one or more of the following:
Validate trigger events which prompt or trigger the execution of the process flow.
Validate and verify inputs to the process flow.
Halt the execution of the process flow when no further action is necessary.
Pause the execution of the process flow when human intervention is deemed to be necessary.
Reduce computational overhead, such as by eliminating unnecessary LLM calls.

In some embodiments, process flow analyzer 152 may implement one or more of the following categories of conditions and rules:
Deterministic conditions: Rule-based conditions which adjust, modify, pause, or halt the process flow, based on predefined conditions.
Smart LLM Filter: A flexible filtering mechanism powered by an LLM that can identify meaningful patterns and nuances in financial data.

Returning to the example of FIG. 5, there is one articulated condition that is applicable to the execution of the process flow (“trigger the process flow only if the customer is one of the internal branches”). This condition logic validates the trigger event (“issuance of invoice by the accounting system”). Thus, if the invoice issued by the accounting system does not identify an internal branch of the enterprise as the customer, the process flow does not start. In this case, the articulated condition can be a standalone action step, or can be incorporated into the trigger event logic.

In some embodiments, the rules and conditions may be rendered in, e.g., natural language, any desired programming language or metalanguage, or using a data exchange format such as JSON.

In step 308, workflow generator 150 executes event monitoring module 154 to continuously monitor for trigger events.

In some embodiments, when event monitoring module 154 detects a trigger event, is executes a process flow associated with the detected trigger event. In the example of FIG. 5, when event monitoring module 154 detects a new invoice issued by the accounting system, workflow generator 150 may start the workflow process associated with invoice processing for enterprise inter-branch sales. In some embodiments, the condition applicable to the execution of this process flow (“trigger the process flow only if the customer is one of the internal branches”) may be applied to validate the trigger event. Thus, unless the invoice issued by the accounting system identifies an internal branch of the enterprise as the customer, the process flow does not start.

In step 310, based on the trigger event detected in step 308, workflow generator 150 may execute execution generator 156 to execute a corresponding structured process.

In the example of FIG. 5, workflow generator 150 may execute execution generator 156 to execute the workflow process associated with invoice processing for enterprise inter-branch sales, as follows:
Parse the issued invoice document.
Categorize items in the received invoice, based on the associated internal branch (e.g., branch 1, branch 2, branch 3).
Sum the total amount for each branch.
Access a debit account for each branch in the accounting system.
Access a sales elimination account in the accounting system.

In some embodiments, workflow generator 150 may execute execution generator 156 to utilize one or more of the following tools in executing one or more of the actions steps of the process flow:
l Retrieval-augmented generation (RAG): Retrieval-augmented generation is

configured to retrieve and incorporate new information that is relevant to the execution of the action step. RAG can be used to supplement information from internal enterprise data stores or approved sources.
API calls: Interfaces with other enterprise and external systems and software, to retrieve relevant trigger events and data.
Reasoning LLM model: Interprets context and generates structured recommendations that require multi-step generation with intermediate steps.

In some embodiments, workflow generator 150 may execute execution generator 156 to validate the execution of one or more of the actions steps using of the process flow a specialized LLM validation model that evaluates the output of each action step, and enforces re-execution when the output fails validation.

In step 312, workflow generator 150 may execute execution generator 156 to execute the final action of the structured process flow executed in step 310.

In the example of FIG. 5, workflow generator 150 may execute execution generator 156 to execute the final action of the workflow process associated with invoice processing for enterprise inter-branch sales, as follows:
Create a journal entry, which comprises one debit item for each internal branch, and a single credit item in the sales elimination account.

In some embodiments, the action steps and final action may be rendered in, e.g., natural language, any desired programming language or metalanguage, or using a data exchange format such as JSON.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

In the description and claims, each of the terms “substantially,” “essentially,” and forms thereof, when describing a numerical value, means up to a 20% deviation (namely, ±20%) from that value. Similarly, when such a term describes a numerical range, it means up to a 20% broader range −10% over that explicit range and 10% below it).

In the description, any given numerical range should be considered to have specifically disclosed all the possible subranges as well as individual numerical values within that range, such that each such subrange and individual numerical value constitutes an embodiment of the invention. This applies regardless of the breadth of the range. For example, description of a range of integers from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 4, and 6. Similarly, description of a range of fractions, for example from 0.6 to 1.1, should be considered to have specifically disclosed subranges such as from 0.6 to 0.9, from 0.7 to 1.1, from 0.9 to 1, from 0.8 to 0.9, from 0.6 to 1.1, from 1 to 1.1 etc., as well as individual numbers within that range, for example 0.7, 1, and 1.1.

The descriptions of the various embodiments of the present invention have been presented for purposes of illustration, but are not intended to be exhaustive or limited to the explicit descriptions. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the description and claims of the application, each of the words “comprise,” “include,” and “have,” as well as forms thereof, are not necessarily limited to members in a list with which the words may be associated.

Where there are inconsistencies between the description and any document incorporated by reference or otherwise relied upon, it is intended that the present description controls.

1. A computer-implemented method comprising:
receiving, as input from a user to a specialized Large Language Model (LLM), a natural language description of a computerized workflow associated with a computerized process-of-interest;
processing said natural language description, using the specialized LLM, to generate a structured, automated process flow configured to automatically_execute said process-of-interest, wherein:
said structured, automated process flow comprises a trigger event, one or more inputs, one or more discrete action steps, and a final action,
said trigger event comprises instructions for automatically acquiring data from one or more of: a computer system, an Application Programming Interface (API), a text message, an electronic mail, a scanned document, or a report,
said one or more inputs comprise instructions for automatically acquiring data from one or more of: a computer system, an API, a text message, an electronic mail, a scanned document, or a report,
said one or more discrete action steps comprise instructions for automatically utilizing one or more of: a Retrieval-Augmented Generation (RAG) tool, an API call, or a reasoning LLM model, and
said final action comprises instructions for automatically performing an action in a computer system;
generating at least one condition applicable to said execution of said process-of-interest; and
upon detecting said trigger event, executing said structured, automated process flow.

2. The computer-implemented method of claim 1, wherein said process-of-interest is any repeated or ad-hoc computerized process defined using a workflow or procedure steps.

3. The computer-implemented method of claim 1, wherein said natural language description identifies at least one of the following categories of elements of said process-of-interest, which the specialized LLM is specialized in processing: said one or more inputs, said trigger event, one or more said action steps, one or more entities responsible for performing each of said one or more action steps, a sequential ordering of said one or more action steps, interdependency between said one or more action steps, said at least one condition, or said final action.

4. The computer-implemented method of claim 1, wherein said one or more inputs comprise structured and unstructured inputs.

5. The computer-implemented method of claim 1, wherein said processing is based, at least in part, on natural language processing (NLP) comprising one or more of natural language understanding (NLU), semantic analysis, contextual analysis, or syntactic analysis.

6. (canceled)

7. The computer-implemented method of claim 1, wherein said at least one condition is configured to perform one or more of the following when said structured, automated process flow is executed: validate said trigger event, validate said inputs, halt said execution of said structured, automated process flow when no further action is necessary, or pause said execution of said structured, automated process flow when human intervention is necessary.

8. A system comprising:
at least one hardware processor; and
a non-transitory computer-readable storage medium having stored thereon program instructions, the program instructions executable by the at least one hardware processor to:
receive, as input from a user to a specialized Large Language Model (LLM), a natural language description of a computerized workflow associated with a computerized process-of-interest,
process said natural language description, using the specialized LLM, to generate a structured, automated process flow configured to automatically execute said process-of-interest, wherein:
said structured, automated process flow comprises a trigger event, one or more inputs, one or more discrete action steps, and a final action,
said trigger event comprises instructions for automatically acquiring data from one or more of: a computer system, an Application Programming Interface (API), a text message, an electronic mail, a scanned document, or a report,
said one or more inputs comprise instructions for automatically acquiring data from one or more of: a computer system, an API, a text message, an electronic mail, a scanned document, or a report,
said one or more discrete action steps comprise instructions for automatically utilizing one or more of: a Retrieval-Augmented Generation (RAG) tool, an API call, or a reasoning LLM model, and
said final action comprises instructions for automatically performing an action in a computer system,
generate at least one condition applicable to said execution of said process-of-interest, and
upon detecting said trigger event, execute said structured, automated process flow.

9. The system of claim 8, wherein said process-of-interest is any repeated or ad-hoc computerized process defined using a workflow or procedure steps.

10. The system of claim 8, wherein said natural language description identifies at least one of the following categories of elements of said process-of-interest, which the specialized LLM is specialized in processing: said one or more inputs, said trigger event, one or more said action steps, one or more entities responsible for performing each of said one or more action steps, a sequential ordering of said one or more action steps, interdependency between said one or more action steps, said at least one condition, or said final action.

11. The system of claim 8, wherein said one or more inputs comprise structured and unstructured inputs.

12. The system of claim 8, wherein said processing is based, at least in part, on natural language processing (NLP) comprising one or more of natural language understanding (NLU), semantic analysis, contextual analysis, or syntactic analysis.

13. (canceled)

14. The system of claim 8, wherein said at least one condition is configured to perform one or more of the following when said structured, automated process flow is executed: validate said trigger event, validate said inputs, halt said execution of said structured, automated process flow when no further action is necessary, or pause said execution of said structured, automated process flow when human intervention is necessary.

15. A computer program product comprising a non-transitory computer-readable storage medium having program instructions embodied therewith, the program instructions executable by at least one hardware processor to:
receive, as input from a user to a specialized Large Language Model (LLM), a natural language description of a computerized workflow associated with a computerized process-of-interest;
process said natural language description, using the specialized LLM, to generate a structured, automated process flow configured to automatically_execute said process-of-interest, wherein:
said structured, automated process flow comprises a trigger event, one or more inputs, one or more discrete action steps, and a final action,
said trigger event comprises instructions for automatically acquiring data from one or more of: a computer system, an Application Programming Interface (API), a text message, an electronic mail, a scanned document, or a report,
said one or more inputs comprise instructions for automatically acquiring data from one or more of: a computer system, an API, a text message, an electronic mail, a scanned document, or a report,
said one or more discrete action steps comprise instructions for automatically utilizing one or more of: a Retrieval-Augmented Generation (RAG) tool, an API call, or a reasoning LLM model, and
said final action comprises instructions for automatically performing an action in a computer system;
generate at least one condition applicable to said execution of said process-of-interest; and
upon detecting said trigger event, execute said structured, automated process flow.

16. The computer program product of claim 15, wherein said process-of-interest is any repeated or ad-hoc computerized process defined using a workflow or procedure steps.

17. The computer program product of claim 15, wherein said natural language description identifies at least one of the following categories of elements of said process-of-interest, which the specialized LLM is specialized in processing: said one or more inputs, said trigger event, one or more said action steps, one or more entities responsible for performing each of said one or more action steps, a sequential ordering of said one or more action steps, interdependency between said one or more action steps, said at least one condition, or said final action.

18. The computer program product of claim 15, wherein said one or more inputs comprise structured and unstructured inputs.

19. The computer program product of claim 15, wherein said processing is based, at least in part, on natural language processing (NLP) comprising one or more of natural language understanding (NLU), semantic analysis, contextual analysis, or syntactic analysis.

20. The computer program product of claim 15, wherein said at least one condition is configured to perform one or more of the following when said structured, automated process flow is executed: validate said trigger event, validate said inputs, halt said execution of said structured, automated process flow when no further action is necessary, or pause said execution of said structured, automated process flow when human intervention is necessary.
